(19) United States
(12) Patent Application Publication
(10) Pub. No.: US 2026/0055276 A1
(43) Pub. Date: Feb. 26, 2026

(54) PIGMENT COMPOSITIONS HAVING A REDUCED CONTENT OF ARYL AMINES OR N-ARYLACETOACETAMIDES AND OXIDATION METHODS FOR PRODUCING THE SAME

(71) Applicant: Xerox Corporation, Norwalk, CT (US)

(72) Inventors: Genggeng QI, Webster, NY (US); Jordan A. FRANK, Rochester, NY (US); Jing X. SUN, Lexington, KY (US); Daniel W. ASARESE, Honeoye Falls, NY (US); Chieh-Min CHENG, Rochester, NY (US); John L. PAWLAK, Rochester, NY (US)

(73) Assignee: Xerox Corporation, Norwalk, CT (US)

(21) Appl. No.: 18/813,307

(22) Filed: Aug. 23, 2024

(51) Int. Cl. C09B 67/20; C09B 33/153

(52) U.S. Cl. CPC C09B 67/0066; C09B 33/153

(57) ABSTRACT

N-arylacetoacetarylide pigment compositions comprise a diazonium coupling product of a first aryl amine and an N-arylacetoacetamide formed from a second aryl amine. N-arylacetoacearylide pigment compositions may be contacted with an oxidant in an aqueous phase to decrease the amount(s) of second aryl amine and/or N-arylacetoacetamide that are present in the N-arylacetoacetarylide pigment composition. The N-arylacetoacetarylide pigment compositions may be present in a pigment dispersion, which may be stably maintained following oxidation.

### FIELD

The present disclosure generally relates to printing, and more specifically, methods for decreasing residual quantities of organic compounds in pigment compositions.

### BACKGROUND

A variety of pigments may be utilized for imparting color to inks and toners. In the present disclosure, the term “pigment” refers equivalently to any of inorganic compounds, organic compounds (inclusive of metal-ligand compounds), and organometallic compounds that may impart color to a desired medium.

Among the classes of organic compounds that are commonly available for imparting color to a desired medium are azo dyes (diazonium coupling products). Azo dyes may be formed by diazotizing an aryl amine to form a diazonium salt, followed by reacting the diazonium salt with another aromatic compound or a nucleophilic carbon atom, such as the central carbon atom in β-dicarbonyl compounds. One such β-dicarbonyl compound that is commonly utilized to form azo dyes is acetoacetic acid (usually in an amidated form through a reaction with another aryl amine, i.e., an N-arylacetoacetamide). Such azo dyes are commonly referred to as N-arylacetoacetarylide pigments.

Although N-arylacetoacetarylide pigments are commonly used in a variety of industries, there are concerns about the aryl amines used in their formation, particularly residual aryl amines remaining after diazotization, as well as N-arylacetoacetamide compounds in the case of N-arylacetoacetarylide pigments. Though N-arylacetoacetarylide pigments are considered safe in most cases, aryl amines have known human health concerns and environmental impacts. Consequently, N-arylacetoacetarylide pigments are commonly rigorously processed following their synthesis to lower the content of residual aryl amines to as low as possible. Removal of residual aryl amines may take place through oxidation, which converts the amine group into a nitro group and/or a polyaniline polymer, both of which present lesser concerns than does the aryl amine itself.

Unfortunately, most conventional oxidation approaches for removing residual aryl amines take place at high temperatures for extended periods of time, which may increase production costs and decrease energy efficiency. Large excesses of oxidant may also be needed. Moreover, many conventional oxidation approaches are also limited in the extent to which the aryl amine content may be reduced. Additionally, conventional oxidation approaches may be ineffective at decreasing the concentration of residual N-arylacetoacetamides, which may release free aryl amine under certain conditions. As a further difficulty, the oxidation conditions may disrupt (destabilize) otherwise stable dispersions of N-arylacetoacetarylide pigments, a commonly utilized commercial form of these colorants.

Accordingly, alternative approaches for improving quality of N-arylacetoacetarylide pigments and their dispersions would be highly desirable.

### SUMMARY

In some embodiments, the present disclosure provides methods for treating N-arylacetoacetarylide pigment compositions. The methods comprise: providing an N-arylacetoacetarylide pigment composition comprising a diazonium coupling product of a first aryl amine and an N-arylacetoacetamide formed from a second aryl amine; wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and contacting the N-arylacetoacetarylide pigment composition with an oxidant in an aqueous phase at a temperature and for a time sufficient to decrease a concentration of the residual N-arylacetoacetamide and/or the residual second aryl amine in the N-arylacetoacetarylide pigment composition.

In some or other embodiments, methods of the present disclosure comprise: providing a pigment dispersion comprising an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine; wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; contacting the pigment dispersion with an oxidant at an alkaline pH at a temperature and for a time sufficient to decrease a concentration of the residual N-arylacetoacetamide and/or the residual second aryl amine in the N-arylacetoacetarylide pigment composition. The dispersion remains stable after being contacted with the oxidant.

In still other embodiments, the present disclosure provides pigment dispersions comprising: an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine; wherein a concentration of residual N-arylacetoacetamide in the pigment dispersion is about 4000 μg/g pigment or below.

### BRIEF DESCRIPTION OF THE DRAWINGS

Not applicable.

### DETAILED DESCRIPTION

The present disclosure generally relates to printing, and more specifically, methods for decreasing residual quantities of organic compounds in pigment compositions.

As discussed above, it may be difficult to promote removal of aryl amines and N-arylacetoacetamides from N-arylacetoacetarylide pigments through oxidation, particularly in an energy-efficient and cost-effective manner. Additionally, in the case of pigment dispersions, destabilization of otherwise stable pigment dispersions may also occur when removing aryl amines and/or N-arylacetoacetamides through oxidation.

The present disclosure addresses these difficulties and provides related advantages as well. In particular, the present disclosure provides oxidative methods that are conducted under conditions that may decrease the concentration of aryl amine and/or an N-arylacetoacetamide intermediate that has not undergone diazonium coupling to produce an N-arylacetoacetarylide azo dye (pigment). Since N-arylacetoacetamide intermediates are often used in a significant stoichiometric excess when forming azo dyes, residual quantities of this intermediate often remain fairly high in the resulting pigment composition. N-arylacetoacetamide intermediates are further a potential source for releasing free aryl amine during formation of a toner or ink or during environmental use, so it may also be desirable to remove as much of this intermediate as possible from finished pigments and their dispersions. The extreme insolubility and limited surface area of N-arylacetoacetarylide pigments is believed to limit the degradation rate of the pigments themselves, both during environmental use and in the methods disclosed herein.

Without being bound by theory or mechanism, the oxidation chemistry is believed to promote removal of aryl amines by forming a radical intermediate through oxidation of the amine group. In a first reaction pathway, the radical intermediate may undergo conversion to the corresponding aryl nitro compound. In a second reaction pathway, the radical intermediate may undergo polymerization to form the corresponding polyaniline. When formed, both products are produced in low amounts that either are removed at a subsequent purification stage and/or are non-volatile and do not present the same issues as the aryl amine itself. For example, an aryl nitro compound may be readily removed during toner manufacturing, and the polyaniline is non-volatile and may be introduced into a toner composition without compromising the toner quality.

Continuing to remain unbound by theory or mechanism, the oxidation chemistry may further promote removal of aryl amines by degrading N-arylacetoacetamides into their constituent aryl amine and acetoacetic acid, either through direct hydrolysis or by first converting the N-arylacetoacetamide the into corresponding N-aryl-N-hydroxyacetoacetamide, followed by hydrolysis to the corresponding aryl hydroxylamine. In either case, the aryl amine or aryl hydroxylamine may undergo conversion to the corresponding aryl nitro compound and/or the corresponding polyaniline according to the description above. Thus, by decreasing the concentration of N-arylacetoacetamide within the pigment composition, the amount of residual aryl amine remaining in the pigment composition or formable in the pigment composition may also be reduced.

The methods of the present disclosure may be conducted upon as-produced pigment solids (e.g., at the presscake stage) or upon a dispersion containing dispersed pigment solids. When the oxidative methods of the present disclosure are conducted upon a pigment dispersion, the oxidation reaction may be conducted under alkaline conditions. Surprisingly, by conducting the oxidation reaction under alkaline conditions, stability of the pigment dispersion may be maintained, even in the presence of dissolved sodium ions. A persulfate oxidant may be desirable for conducting the oxidation under alkaline conditions (pH>7), although a hypochlorite oxidant may also be effective for this purpose, albeit at a higher pH value (pH>12). Although both persulfate and hypochlorite oxidants may be effective for performing oxidation under alkaline conditions according to the disclosure herein, hypochlorite is considered to be the less stable of the two. Oxidant instability may lead to undesirable pH fluctuations, which may lead to eventual dispersion instability. When performing oxidation under neutral or acidic conditions, the dispersion may no longer be stable following oxidation. Another advantage of performing oxidation under alkaline conditions is that oxidation may occur at a faster rate than under neutral conditions. The faster oxidation rate under alkaline conditions may be beneficial for treating both pigment solids and pigment dispersions formed therefrom.

Accordingly, methods of the present disclosure may comprise: providing an N-aryl acetoacetarylide pigment composition comprising a diazonium coupling product of a first aryl amine and an N-aryl acetoacetamide formed from a second aryl amine, in which the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and contacting the N-arylacetoacetarylide pigment composition with an oxidant in an aqueous phase at a temperature and for a time sufficient to decrease a concentration of the residual N-arylacetoacetamide and/or the residual second aryl amine in the N-aryl acetoacetarylide pigment composition.

Depending on the oxidant and whether pigment solids or a pigment dispersion are being treated according to the disclosure herein, the aqueous phase may have an acidic, neutral, or alkaline pH. Preferably, the aqueous phase may have an alkaline pH to realize the benefits discussed above. In non-limiting examples, the aqueous phase may have a pH of about 7.1 to about 14, or about 7.1 to about 12, or about 7.1 to about 10, or about 7.1 to about 8.

An alkaline pH value may be maintained by combining a suitable base with the aqueous phase. In some examples, a hydroxide compound may be combined with the aqueous phase or pigment dispersion to reach a desired pH value. For example, ammonium hydroxide (aqueous ammonia) or an alkali metal hydroxide, such as sodium hydroxide or potassium hydroxide, may be present. In some examples, a carbonate or bicarbonate salt may be combined with the aqueous phase or pigment dispersion to reach a desired pH value. For example, ammonium carbonate or bicarbonate or an alkali metal carbonate or bicarbonate may be combined with the aqueous phase or pigment dispersion to reach a desired pH value. In still other examples, a hydroxide compound and a carbonate or bicarbonate salt may be used in combination with one another to reach a desired pH value. Without being bound by theory or mechanism, the carbonate or bicarbonate salt may buffer the aqueous phase to aid in maintaining the alkaline pH value as the oxidation reaction proceeds. Acidic compounds released during the oxidation reaction may also be neutralized by hydroxide compounds, carbonate salts, bicarbonate salts, or any combination thereof.

The base and the amount thereof that is added to the aqueous phase may be chosen to maintain the pH at a suitable level. Preferably, the amount of base that is added may be selected to minimize the amount of alkali metal cations that remain in the pigment composition following oxidation. In non-limiting examples, the amount of alkali metal cations in the pigment composition following oxidation may range from about 0.2 wt % to about 2 wt %, based on total mass of the pigment composition. The amount of alkali metal cations that may be tolerated in a pigment dispersion may vary depending on the amount of surfactant or other dispersant that is present, for example.

At neutral or alkaline pH values, the oxidant may comprise a persulfate salt, a hypochlorite salt, or any combination thereof. Suitable persulfate salts may include, but are not limited to, ammonium persulfate or alkali metal persulfates, such as sodium persulfate, potassium persulfate, or any combination thereof. Suitable hypochlorite salts may include, for example, sodium hypochlorite, preferably an aqueous alkaline solution thereof.

The amount of oxidant may be chosen to afford a desired degree of removal of the second aryl amine and/or the N-arylacetoacetamide. The oxidant may be present in at least a stoichiometric (at least one molar equivalent) amount relative to a total amount of the second aryl amine in the N-arylacetoacetarylide pigment composition, the total amount of the second aryl amine being a combined amount of free second aryl amine and amidated second aryl amine that is present in the N-arylacetoacetamide. The free second aryl amine and the amidated second aryl amine may afford products that are extractable through utilization of the methods described herein. In non-limiting examples, the oxidant may be present in an amount of about 1.5 molar equivalents or greater, or about 2.5 molar equivalents or greater, or about 5 molar equivalents or greater, or about 10 molar equivalents or greater, or about 15 molar equivalents or greater, or about 20 molar equivalents or greater, each measured relative to the total amount of the second aryl amine in the pigment composition. For instance, suitable amounts of the oxidant relative to the total amount of the second aryl amine may range from about 1.1 molar equivalents to about 30 molar equivalents, or about 1.5 molar equivalents to about 3 molar equivalents, or about 1.5 molar equivalents to about 5 molar equivalents, or about 3 molar equivalents to about 5 molar equivalents, or about 3 molar equivalent to about 10 molar equivalents, or about 5 molar equivalents to about 20 molar equivalents, or about 10 molar equivalents to about 20 molar equivalents, or about 10 molar equivalents to about 15 molar equivalents. Alternately, the oxidant may be present relative to the N-arylacetoacetamide within the foregoing ranges (i.e., the amount of oxidant relative to the N-arylacetoacetamide may range from about 1.1 to about 30 molar equivalents or any subrange thereof). The oxidation reaction may take place exposed to air or pressurized air.

Depending on the chosen oxidant and the amount of oxidant, the oxidation reaction may be conducted over a range of temperatures that are effective to decrease concentrations of the second aryl amine and/or the N-arylacetoacetamide to a sufficient degree. In non-limiting examples, the oxidation reaction may be conducted at a temperature of about 50° C. to about 100° C., or about 50° C. to about 95° C., or about 60° C. to about 90° C., or about 70° C. to about 85° C., or about 75° C. to about 90° C. The oxidation reaction may be conducted at atmospheric pressure or at an elevated pressure. Higher oxidation temperatures than the foregoing may be utilized if an elevated pressure vessel is used.

Furthermore, the oxidation reaction may be conducted for a length of time sufficient to decrease the concentration of the second aryl amine and/or the N-arylacetoacetamide to a desired degree. In non-limiting examples, the length of time may be about 1 hour or greater, or about 2 hours or greater, or about 3 hours or greater, or about 4 hours or greater, or about 6 hours or greater, or about 8 hours or greater. For instance, the oxidation reaction may be conducted for about 1 hour to about 4 hours, or about 2 hours to about 4 hours, or about 3 hours to about 6 hours. The amount of time required may depend on the extent to which lowering of the concentration of the second aryl amine and/or the N-arylacetoacetamide is needed, the chosen oxidant, the chosen pH, and the chosen temperature at which the oxidation reaction takes place. In non-limiting examples, the oxidation reaction may be conducted for about 1 hour to about 4 hours at a temperature of about 50° C. to about 95° C. or about 70° C. to about 90° C.

The methods of the present disclosure may be effective to decrease the concentration of the second aryl amine and/or the N-arylacetoacetamide (i.e., the total amount of the second aryl amine in the N-arylacetoacetarylide pigment composition, as defined above) to a desired degree. In non-limiting examples, the methods of the present disclosure may remove at least about 60%, or at least about 70%, or at least about 80%, or at least about 85%, or at least about 90% of the second aryl amine and/or the N-arylacetoacetamide, as measured on a mass basis relative to the amount of the second aryl amine and/or the N-arylacetoacetamide in the as-produced N-arylacetoacetarylide pigment composition. For instance, the methods of the present disclosure may decrease the concentration of the second aryl amine and/or the N-arylacetoacetamide in the N-arylacetoacetarylide pigment composition by about 60% to about 95%, or about 70% to about 90%, or about 65% to about 85%, as measured on a mass basis relative to the amount of the second aryl amine and/or the N-arylacetoacetamide in the as-produced N-arylacetoacetarylide pigment composition. Preferably, the oxidation reaction may decrease the concentration of the N-arylacetoacetamide by at least about 70%, or at least about 80%, or at least about 85%, or at least about 90%, as measured on a mass basis relative to the amount of the second aryl amine and/or the N-arylacetoacetamide in the as-produced N-arylacetoacetarylide pigment composition.

Prior to oxidation, the N-arylacetoacetamide may be present in an amount up to about 20000 ppm, or up to about 15000 ppm, or up to about 10000 ppm, relative to total mass of the N-arylacetoacetarylide pigment composition. The amount of free second aryl amine, in contrast, may be at least about an order of magnitude lower or at least about two orders of magnitude lower.

In more specific examples, following oxidation, the N-arylacetoacetarylide pigment compositions produced according to the disclosure herein, either as a powder composition or pigment dispersion, may contain an amount of second aryl amine that is about 1000 μg/g pigment or below, or about 800 μg/g pigment or below, or about 600 μg/g pigment or below, or about 400 μg/g pigment or below, or about 200 μg/g pigment or below, or about 100 μg/g pigment or below, such as about 100 μg/g pigment to about 1000 μg/g pigment, or about 200 μg/g pigment to about 800 μg/g pigment, or about 150 μg/g pigment to about 600 μg/g pigment, or about 150 μg/g pigment to about 400 μg/g pigment. In some or other more specific examples, following oxidation, the N-arylacetoacetarylide pigment compositions may contain an amount of N-arylacetoacetamide that is about 5000 μg/g pigment or below, or about 3000 μg/g pigment or below, or about 2500 μg/g pigment or below, or about 2000 μg/g pigment or below, or about 1500 μg/g pigment or below, or about 1000 μg/g pigment or below, such as about 800 μg/g pigment to about 4500 μg/g pigment, or about 800 μg/g pigment to about 1200 μg/g pigment, or about 1000 μg/g pigment to about 2500 μg/g pigment, or about 2000 μg/g pigment to about 4000 μg/g pigment. In some or other more specific examples, following oxidation, the N-arylacetoacetarylide pigment compositions may contain a combined amount of second aryl amine and N-arylacetoacetamide that is about 5000 μg/g pigment or below, or about 3000 μg/g pigment or below, or about 2500 μg/g pigment or below, or about 2000 μg/g pigment or below, or about 1500 μg/g pigment or below, or about 1000 μg/g pigment or below, such as about 800 μg/g pigment to about 4500 μg/g pigment, or about 800 μg/g pigment to about 1200 μg/g pigment, or about 1000 μg/g pigment to about 2000 μg/g pigment, or about 1500 μg/g pigment to about 4000 μg/g pigment, or about 2000 μg/g pigment to about 4000 μg/g pigment. Preferably, following oxidation, the pigment compositions prepared according to the disclosure herein may contain the second aryl amine in an amount of about 100 μg/g pigment to about 500 μg/g pigment, or about 50 μg/g pigment to about 400 μg/g pigment; the N-arylacetoacetamide in an amount of about 1000 μg/g pigment to about 4000 μg/g pigment, or about 1000 μg/g pigment to about 3000 μg/g pigment, or about 1500 μg/g pigment to about 2500 μg/g pigment, and a combined amount of second aryl amine and N-arylacetoacetamide in an amount of about 1500 μg/g pigment to about 4500 μg/g pigment, or about 1500 μg/g pigment to about 3500 μg/g pigment, or about 2000 μg/g pigment to about 3000 μg/g pigment.

Any N-arylacetoacetarylide containing a residual N-arylacetoacetamide and/or aryl amine may be mitigated through use of the disclosure herein. Examples of the second aryl amines that may be present, either alone and/or in amidated form, may include, but are not limited to, aniline, 2-chloroaniline, 3-chloroaniline, 4-chloroaniline, 2-methylaniline (o-toludine), 3-methylaniline, 4-methylaniline, 2,4-dimethylaniline, 2-methoxyaniline (o-anisidine), 3-methoxyaniline, 4-methoxyaniline, 2,4,5-trimethoxyaniline, 4-chloro-2,5-dimethoxyaniline, 5-amino-1,3-dihydro-2H-benzo [d] imidazol-2-one, and the like. Example pigment compositions in which the aryl amines may be present include, but are not limited to, Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 83, Pigment Yellow 97, Pigment Yellow 151, Pigment Yellow 154, Pigment Yellow 180, Pigment Yellow 194, or any combination thereof.

In some examples, the oxidation methods of the present disclosure may be conducted upon a pigment dispersion, wherein the oxidation reaction is conducted such that the pigment dispersion remains stable following oxidation. Additional components that may be present within such pigment dispersions are discussed in more detail below.

In some examples, oxidation of pigment dispersions to remove an aryl amine and/or an N-arylacetoacetamide may comprise: providing a pigment dispersion comprising an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine, in which the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; contacting the pigment dispersion with an oxidant under alkaline conditions at a temperature and for a time sufficient to decrease a concentration of the residual N-aryl acetoacetamide and/or the residual second aryl amine in the N-arylacetoacetarylide pigment composition, in which the dispersion remains stable after being contacted with the oxidant. Preferably, the oxidant may comprise a persulfate, such as a persulfate salt like ammonium persulfate, sodium persulfate, potassium persulfate, or any combination thereof. Sodium persulfate may be particularly desirable.

In some examples, the pigment dispersion may be heated in air at a temperature of about 50° C. or above before combining the pigment dispersion with the oxidant. At atmospheric pressure, a maximum heating temperature may be about 100° C. Optionally, such heating in air may be conducted in the presence of the base before the oxidant is combined with the pigment dispersion. However, in other embodiments, the base may be combined with the pigment dispersion in combination with the oxidant, or even after the oxidant.

In some examples, the pigment dispersions may comprise water-miscible organic solvents such as, for example, monoprotic alcohols, glycols or polyols, or glycol or polyol monoethers or monoesters. Examples of such water-miscible organic solvents may include, but are not limited to, C₅₊ monohydric alcohols, C₂₊ glycols or polyols, C₂₊ glycol or polyol monoethers or monoesters, C₂₊ amides, cyclic carbonates, dimethylsulfoxide, tetramethylene sulfone, or any combination thereof. As used herein, the term “glycol” refers to an organic molecule containing two or more alcohol groups, which may be vicinal (located on adjacent carbon atoms) or non-vicinal (located on non-adjacent carbon atoms). As used herein, the term “polyol” refers to an organic molecule containing three or more alcohol groups, which may be located upon adjacent and/or non-adjacent carbon atoms.

More specific examples of water-miscible organic solvents that may be present in the pigment dispersions include, but are not limited to, cyclohexanol, furfuryl alcohol, tetrahydrofurfuryl alcohol, ethylene glycol, diethylene glycol, propylene glycol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 2-methyl-2,4-pentanediol, hexanetriol, thiodiglycol, tetraethylene glycol, 3-methoxy-1-butanol, 2-butoxyethanol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monopropyl ether, propylene glycol monobutyl ether, dipropylene glycol, dipropylene glycol monomethyl ether, dipropylene glycol monoethyl ether, dipropylene glycol monopropyl ether, tripropylene glycol methyl ether, ethylene glycol diacetate, ethylene glycol monomethyl ether acetate, ethylene glycol monobutyl ether acetate, diethylene glycol monoethyl ether acetate, ethylene carbonate, propylene carbonate, diacetone alcohol, 1-methyl-4-piperidone, cyrene, pentanamide, N-methylbutanamide, butylformamide, N,N-dimethylacetamide, N,N-diethylacetamide, pyrrolidone, N-methyl-2-pyrrolidone, N-propyl-pyrrolidone, N-butyl-pyrrolidone, N-vinyl-2-pyrrolidone, oxazolidone, piperidinone, N-ethyl-valerolactam, N-propyl-valerolactam, N-butyl-valerolactam, caprolactam, N-ethyl-caprolactam, N-propyl-caprolactam, dimethyl sulfoxide, tetramethylene sulfone, or any combination thereof. Still other examples of organic solvents that may be present include, for example, ethylene glycol.

diethylene glycols, glycerol, dipropylene glycols, polyethylene glycols, polypropylene glycols, trimethylolpropane, 1,5-pentanediol, 2-methyl-1,3,-propanediol, 2-ethyl-2-hydroxymethyl-1,3-propanediol, 3-methoxybutanol, 3-methyl-1,5-pentanediol, 1,3-propanediol, 1,4-butanediol, 2.4-heptanediol, amides, ethers, urea, substituted ureas such as thiourea, ethylene urea, alkylurea, alkylthiourea, dialkylurea, and dialkylthiourea, carboxylic acids and their salts, such as 2-methylpentanoic acid, 2-ethyl-3-propylacrylic acid, 2,ethylhexanoic acid, 3-ethoxyproponic, acid, esters, organosulfides, organosulfoxides, sulfones (such as sulfolane), carbitol, butyl carbitol, ethers, tripropylene glycol monomethyl ether, ether derivatives, hydroxyethers, amino alcohols, ketones, N-methylpyrrolidinone, 2-pyrrolidinone, cyclohexylpyrrolidone, amides, sulfoxides, lactones, polyelectrolytes, methyl sulfonylethanol, imidazole, 1,3-dimethyl-2-imidazolidinone, substituted and unsubstituted formamides, substituted and unsubstituted acetamides, the like, or any combination thereof.

In non-limiting examples, the water-miscible organic solvent may be present in the pigment dispersion in an amount ranging from about 1 wt % to about 60 wt %, based upon a total mass, such as about 10 wt % to about 30 wt %, or about 25 wt % to about 55 wt %, or about 30 wt % to about 60 wt %, or about 40 wt % to about 60 wt %, or about 50 wt % to about 60 wt %, each based upon total mass of the pigment dispersion.

The pigment dispersions may further include a polymeric dispersant, a surfactant, or any combination thereof. The polymeric dispersant and/or the surfactant may aid in dispersing pigment particles within the aqueous phase to result in a stable dispersion. Preferably, the polymeric dispersant, if present, is dissolved in the aqueous phase.

Suitable polymeric dispersants are not believed to be particularly limited, provided that the polymeric dispersant, if used, may promote formation of a stable dispersion of the N-arylacetoacetarylide pigment in an aqueous phase. For example, the polymeric dispersant may be a vinyl polymer having additional functionality suitable to promote dispersion of the N-arylacetoacetarylide pigment. The additional functionality may comprise a carboxylic acid or sulfonic acid, for example. In one or more examples, the polymeric dispersant may comprise an acrylate polymer or copolymer. The term “acrylate” equivalently refers to polymers derived from acrylic acid or methacrylic acid, esters thereof, or copolymers thereof. Suitable acrylate polymers may be prepared by free radical polymerization of one or more acrylate monomers, for example.

Acrylate monomers that may be present in the polymeric dispersants include, but are not limited to, acrylic acid, methacrylic acid, acrylate or methacrylate esters (e.g., methyl acrylate or methacrylate, ethyl acrylate or methacrylate, 2-ethylhexyl acrylate or methacrylate, cycloalkyl acrylates or methacrylates, benzyl acrylate or methacrylate, and fatty alcohol acrylates or methacrylates, such as those containing capryl, capric, lauryl, myristyl, cetyl, or stearyl alcohol as the alcohol component of the ester).

In non-limiting examples, the N-arylacetoacetarylide pigment may be included in the pigment dispersions in an amount of about 0.05 wt % to about 30 w1%, or about 0.1 wt % to about 25 wt %, or about 5 wt % to about 25 wt %, or about 12 wt % to about 20 wt %, based on total mass.

In non-limiting examples, a mass ratio of N-arylacetoacetarylide pigment to polymeric dispersant, if used, may range from about 20:1 to about 1:1. or about 10:1 to about 1:1, or about 8:1 to about 1:1, or about 6:1 to about 1:1, or about 5:1 to about 1:1.

Small-molecule surfactants may also be suitably used as an alternative to polymeric dispersants. Suitable surfactants may include anionic surfactants, neutral surfactants, zwitterionic surfactants, or any combination thereof. When present, a surfactant may be included in the pigment dispersions in an amount of about 0.01 w1% to about 10 wt %, or about 0.01 wt % to about 5 wt9%, or about 0.02 wt % to about 5 wt %, or about 0.75 wt % to about 4 wt %, or about 1 wt % to about 3 wt %, based on total mass.

Preferably, at least one anionic surfactant may be present in the pigment dispersions, such as one or more sulfate or sulfonate surfactants. Examples of suitable anionic surfactants may include, but are not limited to, sodium dodecylsulfate (SDS), sodium dodecylbenzenesulfonate, sodium dodecylnaphthalene sulfate, dialkyl benzenealkyl sulfates and sulfonates, abietic acid, and the NEOGEN brand of anionic surfactants. Such surfactants may suitably have a straight-chain or branched alkyl group. Non-limiting examples of suitable commercial examples of anionic surfactants may include, for instance, NEOGEN R-K (Daiichi Kogyo Seiyaku Co., Ltd. Japan), CALFAX DB-45 (Pilot Corporation), and TAYCAPOWER BN2060 (Tayca Corporation, Japan).

Other specific examples of suitable surfactants may include, for instance, alkyl polyethylene oxides, alkyl phenyl polyethylene oxides, polyethylene oxide block copolymers, acetylenic polyethylene oxides, polyethylene oxide (di)esters, polyethylene oxide amines, polyoxyethylene alkyl ethers, polyoxyethylene alkyl esters, acetylene alcohols, acetylene glycols, 2-heptadecenyl-hydroxyethylimidazoline, dihydroxyethylstearylamine, stearyldimethylbetaine, lauryldihydroxyethylbetaine, fluorosurfactants, methalose, methyl cellulose, ethyl cellulose, propyl cellulose, hydroxyethyl cellulose, carboxymethyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, block copolymers of polyethylene oxide and polypropylene oxide, sodium dodecylsulfate (SDS), sodium dodecylbenzene sulfonate, sodium dodecylnaphthalene sulfate, dialkyl benzenealkyl sulfates and sulfonates, acids such as abietic acid, alkyldiphenyloxide disulfonates, branched sodium dodecyl benzene sulfonates, and any combination thereof.

The pigment dispersions may also include a suitable biocide in an amount effective to suppress growth of microorganisms, such as mold, bacteria, algae, fungi, and the like. An amount of the biocide may range from about 100 ppm to about 500 ppm relative to an amount of dry pigment. Examples of suitable biocides will be familiar to persons having ordinary skill in the art. In some examples, PROXEL GXL (1,2-benzisothiazolin-3-one) may be a suitable biocide. Other suitable biocides may include, for example, 5-chloro-2-methyl-4-isothiazolin-3-one, 2-methyl-4-isothiazolin-3-one, 1,2-benzisothiazolin-3-one, or any combination thereof.

The N-arylacetoacetarylide pigment may be dispersed as solids (i.e., in the form of particulates) within the pigment dispersions in the presence of a suitable amount of polymeric dispersant and/or surfactant. Suitable particle sizes for the N-arylacetoacetarylide pigment within the pigment dispersions may include an average diameter (D50) of about 20 nm to about 500 nm, or about 40 nm to about 400 nm, or about 60 nm to about 200 nm. Particle sizes may be determined by a dynamic light scattering particle size analyzer, such as a Malvern Mastersizer instrument or a Nanotrac Flex instrument. Pigment particles may be spherical or non-spherical in shape.

Embodiments disclosed herein include the following:

Embodiment 1. A method comprising:
providing an N-arylacetoacetarylide pigment composition comprising a diazonium coupling product of a first aryl amine and an N-arylacetoacetamide formed from a second aryl amine;
   wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and
contacting the N-arylacetoacetarylide pigment composition with an oxidant in an aqueous phase at a temperature and for a time sufficient to decrease a concentration of the residual N-arylacetoacetamide and/or the residual second aryl amine in the N-arylacetoacetarylide pigment composition.

Embodiment 2. The method of Embodiment 1, wherein the aqueous phase has an alkaline pH.

Embodiment 3. The method of Embodiment 2, wherein the alkaline pH is maintained by a hydroxide compound, a carbonate salt, a bicarbonate salt, or any combination thereof.

Embodiment 4. The method of any one of Embodiments 1-3, wherein the oxidant comprises a persulfate salt, a hypochlorite salt, or any combination thereof.

Embodiment 5. The method of any one of Embodiments 1-4, wherein the temperature is about 50° C. to about 95° C. and the time is about 1 hour to about 4 hours.

Embodiment 6. The method of any one of Embodiments 1-5, wherein the temperature is about 70° C. to about 90° C.

Embodiment 7. The method of any one of Embodiments 1-6, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

Embodiment 8. The method of any one of Embodiments 1-7, wherein the second aryl amine is o-anisidine.

Embodiment 9. The method of any one of Embodiments 1-8, wherein the temperature and time are sufficient to decrease the concentration of the N-arylacetoacetamide by at least about 80% on a mass basis relative to the N-arylacetoacetarylide pigment composition.

Embodiment 10. A method comprising:
providing a pigment dispersion comprising an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine;
   wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide;
contacting the pigment dispersion with an oxidant at an alkaline pH at a temperature and for a time sufficient to decrease a concentration of the residual N-arylacetoacetamide and/or the residual second aryl amine in the N-arylacetoacetarylide pigment composition;
wherein the dispersion remains stable after being contacted with the oxidant.

Embodiment 11. The method of Embodiment 10, wherein the oxidant comprises a persulfate salt.

Embodiment 12. The method of Embodiment 11, wherein the persulfate salt comprises ammonium persulfate, sodium persulfate, or any combination thereof.

Embodiment 13. The method of any one of Embodiments 10-12, wherein the alkaline pH is about 7.1 to about 14.

Embodiment 14. The method of any one of Embodiments 10-13, wherein the alkaline pH is maintained by a hydroxide compound, a carbonate salt, a bicarbonate salt, or any combination thereof.

Embodiment 15. The method of any one of Embodiments 10-14, wherein the temperature is about 50° C. to about 95° C. and/or the time is about 1 hour to about 4 hours.

Embodiment 16. The method of any one of Embodiments 10-15, wherein the temperature is about 70° C. to about 90° C.

Embodiment 17. The method of any one of Embodiments 10-16, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

Embodiment 18. The method of any one of Embodiments 10-17, wherein the second aryl amine is o-anisidine.

Embodiment 19. The method of any one of Embodiments 10-18, wherein the temperature and time are sufficient to decrease the concentration of the N-arylacetoacetamide by at least about 80% on a mass basis relative to the N-arylacetoacetarylide pigment composition in the pigment dispersion.

Embodiment 20. The method of any one of Embodiments 10-19, further comprising:
heating the pigment dispersion in air at a temperature of about 50° C. or above before contacting the oxidant with the pigment dispersion.

Embodiment 21. The method of Embodiment 20, wherein a base is combined with the pigment dispersion while being heated and before being contacted with the oxidant;
wherein the base comprises a hydroxide compound, a carbonate salt, a bicarbonate salt, or any combination thereof.

Embodiment 22. A pigment dispersion comprising:
an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine;
   wherein a concentration of residual N-arylacetoacetamide in the pigment dispersion is about 4000 μg/g pigment or below.

Embodiment 23. The pigment dispersion of Embodiment 22, wherein a concentration of residual second aryl amine in the pigment dispersion is about 400 μg/g pigment or below.

To facilitate a better understanding of the present disclosure, the following examples of preferred or representative embodiments are given. In no way should the following examples be read to limit, or to define, the scope of the invention.

### EXAMPLES

Control. Pigment Yellow 74 (PY74) Pigment Dispersion. A PY74 pigment dispersion was obtained from Heubach Colorants USA LLC. The pristine PY74 pigment dispersion had a pigment solids content of about 18% by weight and a total solids content of about 19.8% by weight.

Sample 1A (Comparative). 10 g of the pristine PY74 pigment dispersion was combined with 2 g of deionized water. Thereafter, the mixture was heated to 80° C. in air and maintained at that temperature for 2 hours. After heating, the sample was rapidly cooled to room temperature and further analyzed.

Sample 1B (Comparative). This sample was prepared in the same manner as Sample 1A, except heating was conducted for 3 hours in air at 80° C.

Sample 2 (Comparative). 10 g of the pristine PY74 pigment dispersion was combined with 0.5 g of 0.3 M nitric acid and 1.5 g of deionized water. Thereafter, the mixture was heated to 80° C. in air and maintained at that temperature for 2 hours. After heating, the sample was rapidly cooled to room temperature and further analyzed.

Sample 3 (Comparative). 10 g of the pristine PY74 pigment dispersion was combined with 0.05 g of sodium hydroxide and 2 g of deionized water. Thereafter, the mixture was heated to 80° C. in air and maintained at that temperature for 2 hours. After heating, the sample was rapidly cooled to room temperature and further analyzed.

Sample 4 (Inventive). 10 g of the pristine PY74 pigment dispersion was combined with 0.48 g of ammonium persulfate and 2 g of deionized water. Thereafter, the mixture was heated to 80° C. in air and maintained at that temperature for 2 hours. After heating, the sample was rapidly cooled to room temperature and further analyzed.

Sample 5 (Comparative). 10 g of the pristine PY74 pigment dispersion was combined with 0.48 g of ammonium persulfate, 0.5 g of 0.3 M nitric acid, and 1.5 g of deionized water. Thereafter, the mixture was heated to 80° C. in air and maintained at that temperature for 2 hours. After heating, the sample was rapidly cooled to room temperature and further analyzed.

Sample 6 (Inventive). 10 g of the pristine PY74 pigment dispersion was combined with 0.48 g of ammonium persulfate, 0.24 g sodium hydroxide, and 2 g of deionized water. Thereafter, the mixture was heated to 80° C. in air and maintained at that temperature for 2 hours. After heating, the sample was rapidly cooled to room temperature and further analyzed.

Sample 7A (Inventive). 6 g of Sample 1A was combined with 0.24 g of ammonium persulfate and 2 g of deionized water. Thereafter, the mixture was heated to 80° C. in air and maintained at that temperature for 2 hours. After heating, the sample was rapidly cooled to room temperature and further analyzed.

Samples 7B-1 and 7B-2 (Inventive). 6 g of Sample 1B was combined with 0.484 g of ammonium persulfate and 2 g of deionized water. Thereafter, the mixture was heated to 80° C. in air and maintained at that temperature for 2 hours (Sample 7B-1) or 4 hours (Sample 7B-2). After heating, the sample was rapidly cooled to room temperature and further analyzed.

Sample 7C (Inventive). 6 g of Sample 1B was combined with 0.0484 g of ammonium persulfate and 2 g of deionized water. Thereafter, the mixture was heated to 50° C. in air and maintained at that temperature for 2 hours, followed by heating to 80° C. and maintaining at that temperature for an additional 2 hours. After heating, the sample was rapidly cooled to room temperature and further analyzed.

Sample 8 (Comparative). 6 g of Sample 2 was combined with 0.24 g of ammonium persulfate and 2 g of deionized water. Thereafter, the mixture was heated to 80° C. in air and maintained at that temperature for 2 hours. After heating, the sample was rapidly cooled to room temperature and further analyzed.

Sample 9 (Inventive). 6 g of Sample 3 was combined with 0.24 g of ammonium persulfate, 0.12 g sodium hydroxide, and 2 g of deionized water. Thereafter, the mixture was heated to 80° C. in air and maintained at that temperature for 2 hours. After heating, the sample was rapidly cooled to room temperature and further analyzed.

Sample 10 (Inventive). 6 g of Sample 6 was combined with 0.24 g of ammonium persulfate, 0.13 g sodium hydroxide, and 2 g of deionized water. Thereafter, the mixture was heated to 80° C. in air and maintained at that temperature for 2 hours. After heating, the sample was rapidly cooled to room temperature and further analyzed.

Samples 11A and 11B (Inventive). 6 g of Sample 1B was combined with 0.0484 g of ammonium persulfate, 0.0150 g sodium bicarbonate, and 2 g of deionized water. Thereafter, the mixture was heated to 50° C. in air and maintained at that temperature for 2 hours (Sample 11A), followed by heating to 80° C. and maintaining at that temperature for an additional 2 hours (Sample 11B). After heating, the sample was rapidly cooled to room temperature and further analyzed.

Samples 11C and 11D (Inventive). These samples were prepared and treated in the same manner as Samples 11A and 11B, respectively, except the amounts of ammonium persulfate and sodium bicarbonate were halved.

Sample 11E and 11F (Inventive). These samples were prepared and treated in the same manner as Samples 11C and 11D, except the sodium bicarbonate was omitted.

Sample 12 (Inventive). 4.2 kg of the pristine PY74 pigment dispersion was combined with 88 g of 25 wt % aqueous sodium hydroxide solution. The mixture was heated to 85° C. in air and held at that temperature for 1 hour. Thereafter, a solution of 170 g sodium persulfate dissolved in 100 g of deionized water and an additional 240 g of 25 wt % aqueous sodium hydroxide solution were added to the heated mixture. The combined mixture was maintained at 85° C. in air for an additional 2 hours. After heating, the sample was rapidly cooled to room temperature and further analyzed.

Sample 13 (Comparative). 10 g of pristine PY74 dispersion was combined with 0.14 g of 50 wt % aqueous hydrogen peroxide, 0.15 g of formic acid, and 1.7 g of deionized water. Thereafter, the mixture was heated to 80° C. in air and maintained at that temperature for 2 hours. After heating, the sample was rapidly cooled to room temperature and further analyzed.

Sample 14 (Comparative). 10 g of pristine PY74 dispersion was combined with 0.14 g of 50 wt % aqueous hydrogen peroxide and 1.9 g of deionized water. Thereafter, the mixture was heated to 80° C. in air and maintained at that temperature for 2 hours. After heating, the sample was rapidly cooled to room temperature and further analyzed.

Sample 15 (Comparative). 1.8 g of Sample 3 was combined with 0.02 g of 50 wt % aqueous hydrogen peroxide. Thereafter, the mixture was heated to 80° C. in air and maintained at that temperature for 2 hours. After heating, the sample was rapidly cooled to room temperature and further analyzed.

Sample 16 (Inventive). 10 g of pristine PY74 dispersion was combined with 1.6 g aqueous sodium hypochlorite solution (11% chlorine by weight) and 0.4 g of deionized water. Thereafter, the mixture was heated to 80° C. in air and maintained at that temperature for 2 hours. After heating, the sample was rapidly cooled to room temperature and further analyzed.

Sample 17 (Inventive). 1.8 g of Sample 3 was combined with 0.2 g aqueous sodium hypochlorite solution (11% chlorine by weight). Thereafter, the mixture was heated to 80° C. in air and maintained at that temperature for 2 hours. After heating, the sample was rapidly cooled to room temperature and further analyzed.

The dispersion stability of each sample was also evaluated qualitatively at the end of the heating period.

Each sample was analyzed by liquid chromatography (LC) with UV detection for o-anisidine (OA) and the o-anisidine amide of acetoacetic acid (AAOA). For the LC/UV chromatography, the samples were vortexed for 5 minutes, and 0.5 g sample was weighed into a 20 mL scintillation vial and combined with 5 mL THF. The sample was mechanically shaken for 60 minutes and then combined with 15 mL methanol, followed by an additional 60 minutes of mechanical shaking. Finally, the sample was diluted 10-fold with deionized water and filtered through a 0.2 μm nylon filter. LC separation was conducted at 50° C. on an Agilent 1280 LC system with a Poroshell 120 EC-C18 2.7 μm column at a flow rate of 1 mL/min and a gradient from 27% methanol/73% 12 mM ammonium acetate to 100% methanol over 8 minutes. UV detection was conducted at 281 nm.

Table 1 below summarizes the treatment conditions for each sample, the OA and AAOA concentrations following treatment, and the resulting dispersion stability. The pH values in Table 1 were determined following the heating period.

TABLE 1

| | | | | | | Total | |
|---|---|---|---|---|---|---|---|
| | | Molar | | | | OA + | |
| | | Equivalents | | OA | AAOA | AAOA | Dispersion |
| Sample | Description | of Oxidant | pH | (μg/g) | (μg/g) | (μg/g) | Stability |
| Control | 18 wt % PY74 | none | 6 | 420 | 14197 | 14617 | Y |
| | dispersion | | | | | | |
| 1A (Comp.) | 2 hr in air @80° C., | none | 6 | 1545 | 12524 | 14069 | Y |
| | no oxidant | | | | | | |
| 1B (Comp.) | 3 hr in air @80° C., | none | 6 | 2851 | 12599 | 15450 | Y |
| | no oxidant | | | | | | |
| 2 (Comp.) | 2 hr in air @80° C. | none | 3 | 2181 | 12272 | 14453 | Y |
| | w/HNO₃, no | | | | | | |
| | oxidant | | | | | | |
| 3 (Comp.) | 2 hr in air @80° C. | none | 12 | 1465 | 10170 | 11635 | Y |
| | w/NaOH, no | | | | | | |
| | oxidant | | | | | | |
| 4 (Inv.) | 2 hr in air @80° C., | 15x | <7 | 113 | 4296 | 4409 | N |
| | APS oxidant | | | | | | |
| 5 (Comp.) | 2 hr in air @80° C. | 15x | <7 | 106 | 4442 | 4548 | N |
| | w/HNO₃, APS | | | | | | |
| | oxidant | | | | | | |
| 6 (Inv.) | 2 hr in air @80° C. | 15x | 9 | 471 | 1498 | 1969 | Y |
| | w/NaOH, APS | | | | | | |
| | oxidant | | | | | | |
| 7A (Inv.) | 1) 2 hr in air | 15x | <7 | 124 | 4429 | 4553 | N |
| | @80° C., | | | | | | |
| | no oxidant | | | | | | |
| | 2) 2 hr in air | | | | | | |
| | @80° C., APS | | | | | | |
| | oxidant | | | | | | |
| 7B-1 (Inv.) | 1) 3 hr in air | 30x | <7 | 305 | 9947 | 10252 | N |
| | @80° C., | | | | | | |
| | no oxidant | | | | | | |
| | 2) 2 hr in air | | | | | | |
| | @80° C., APS | | | | | | |
| | oxidant | | | | | | |
| 7B-2 (Inv.) | 1) 3 hr in air | 30x | <7 | 206 | 4907 | 5113 | N |
| | @80° C., | | | | | | |
| | no oxidant | | | | | | |
| | 2) 4 hr in air | | | | | | |
| | @80° C., APS | | | | | | |
| | oxidant | | | | | | |
| 7C (Inv.) | 1) 3 hr in air | 3x | <7 | 318 | 8621 | 8939 | N |
| | @80° C., | | | | | | |
| | no oxidant | | | | | | |
| | 2) 2 hr in air | | | | | | |
| | @50° C. + 2 hr in | | | | | | |
| | air @80° C., APS | | | | | | |
| | oxidant | | | | | | |
| 8 (Comp.) | 1) 2 hr in air | 15x | <7 | 106 | 4420 | 4526 | N |
| | @80° C. w/HNO₃, | | | | | | |
| | no oxidant | | | | | | |
| | 2) 2 hr in air | | | | | | |
| | @80° C., APS | | | | | | |
| | oxidant | | | | | | |
| 9 (Inv.) | 1) 2 hr in air | 15x | 9 | 469 | 972 | 1441 | Y |
| | @80° C. w/NaOH, | | | | | | |
| | no oxidant | | | | | | |
| | 2) 2 hr in air | | | | | | |
| | @80° C. w/NaOH, | | | | | | |
| | APS oxidant | | | | | | |
| 10 (Inv.) | 1) 2 hr in air | 30x | 9 | 301 | 857 | 1158 | Y |
| | @80° C. w/NaOH, | | | | | | |
| | APS oxidant | | | | | | |
| | 2) 2 hr in air | | | | | | |
| | @80° C. w/NaOH, | | | | | | |
| | APS oxidant | | | | | | |
| 11A (Inv.) | 1) 3 hr in air | 3x | >7 | 325 | 9947 | 10272 | Y |
| | @80° C., | | | | | | |
| | no oxidant | | | | | | |
| | 2) 2 hr in air | | | | | | |
| | @50° C. w/ | | | | | | |
| | NaHCO₃, APS | | | | | | |
| | oxidant | | | | | | |
| 11B (Inv.) | 1) 3 hr in air | 3x | >7 | 298 | 9284 | 10570 | Y |
| | @80° C., | | | | | | |
| | no oxidant | | | | | | |
| | 2) 2 hr in air | | | | | | |
| | @50° C. + 2 hr in | | | | | | |
| | air @80° C. w/ | | | | | | |
| | NaHCO₃, APS | | | | | | |
| | oxidant | | | | | | |
| 11C (Inv.) | 2 hr in air @50° C. | 1.5x | >7 | 325 | 9947 | 10272 | Y |
| | w/NaHCO₃, APS | | | | | | |
| | oxidant | | | | | | |
| 11D (Inv.) | 2 hr in air @50° C. | 1.5x | >7 | 298 | 9284 | 9582 | Y |
| | w/NaHCO₃ + 2 hr | | | | | | |
| | in air @80° C. w/ | | | | | | |
| | NaHCO₃, APS | | | | | | |
| | oxidant | | | | | | |
| 11E Inv.) | 2 hr in air @50° C., | 1.5x | <7 | 610 | 10610 | 11220 | Y |
| | APS oxidant | | | | | | |
| 11F (Inv.) | 2 hr in air @50° C. + | 1.5x | <7 | 318 | 8621 | 8939 | Y |
| | 2 hr in air | | | | | | |
| | @80° C., APS | | | | | | |
| | oxidant | | | | | | |
| 12 (Inv.) | 1) 1 hr in air | 14x | 9 | 149 | 1424 | 1573 | Y |
| | @85° C. w/NaOH, | | | | | | |
| | no oxidant | | | | | | |
| | 2) 2 hr in air | | | | | | |
| | @85° C. w/NaOH, | | | | | | |
| | SPS oxidant | | | | | | |
| 13 (Comp.) | 2 hr in air @80° C. | 15x | 3 | 212 | 5172 | 5384 | Y |
| | w/formic acid, | | | | | | |
| | H₂O₂ oxidant | | | | | | |
| 14 (Comp.) | 2 hr in air @80° C., | 15x | 6 | 831 | 11778 | 12609 | Y |
| | H₂O₂ oxidant | | | | | | |
| 15 (Comp.) | 1) 2 hr in air | 15x | 12 | 1534 | 5402 | 6936 | Y |
| | @80° C. w/NaOH, | | | | | | |
| | no oxidant | | | | | | |
| | 2) 2 hr in air | | | | | | |
| | @80° C., H₂O₂ | | | | | | |
| | oxidant | | | | | | |
| 16 (Inv.) | 2 hr in air @80° C., | 30x | — | 199 | 7294 | 7493 | N |
| | NaOCl oxidant | | | | | | |
| 17 (Inv.) | 1) 2 hr in air | 3x | — | 360 | 6854 | 7214 | N |
| | @80° C., no | | | | | | |
| | oxidant | | | | | | |
| | 2) 2 hr in air | | | | | | |
| | @80° C., NaOCl | | | | | | |
| | oxidant | | | | | | |

As shown in Table 1. OA and AAOA concentrations experienced the greatest decrease under alkaline oxidative conditions, while still maintaining dispersion stability. Under alkaline oxidative conditions, the OA and AAOA concentrations decreased by a factor of about 7-to 13-fold relative to the control.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A method comprising:
providing an N-arylacetoacetarylide pigment composition comprising a diazonium coupling product of a first aryl amine and an N-arylacetoacetamide formed from a second aryl amine;
wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and
contacting the N-arylacetoacetarylide pigment composition with an oxidant in an aqueous phase at a temperature and for a time sufficient to decrease a concentration of the residual N-arylacetoacetamide and/or the residual second aryl amine in the N-arylacetoacetarylide pigment composition.

2. The method of claim 1, wherein the aqueous phase has an alkaline pH.

3. The method of claim 2, wherein the alkaline pH is maintained by a hydroxide compound, a carbonate salt, a bicarbonate salt, or any combination thereof.

4. The method of claim 2, wherein the oxidant comprises a persulfate salt, a hypochlorite salt, or any combination thereof.

5. The method of claim 2, wherein the temperature is about 50° C. to about 95° C. and the time is about 1 hour to about 4 hours.

6. The method of claim 2, wherein the temperature is about 70° C. to about 90° C.

7. The method of claim 2, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

8. The method of claim 2, wherein the second aryl amine is o-anisidine.

9. The method of claim 2, wherein the temperature and time are sufficient to decrease the concentration of the N-arylacetoacetamide by at least about 80% on a mass basis relative to the N-arylacetoacetarylide pigment composition.

10. A method comprising:
providing a pigment dispersion comprising an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine;
wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide;
contacting the pigment dispersion with an oxidant at an alkaline pH at a temperature and for a time sufficient to decrease a concentration of the residual N-arylacetoacetamide and/or the residual second aryl amine in the N-arylacetoacetarylide pigment composition;
wherein the dispersion remains stable after being contacted with the oxidant.

11. The method of claim 10, wherein the oxidant comprises a persulfate salt.

12. The method of claim 11, wherein the persulfate salt comprises ammonium persulfate, sodium persulfate, or any combination thereof.

13. The method of claim 10, wherein the alkaline pH is about 7.1 to about 14.

14. The method of claim 10, wherein the alkaline pH is maintained by a hydroxide compound, a carbonate salt, a bicarbonate salt, or any combination thereof.

15. The method of claim 10, wherein the temperature is about 50° C. to about 95° C. and/or the time is about 1 hour to about 4 hours.

16. The method of claim 10, wherein the temperature is about 70° C. to about 90° C.

17. The method of claim 10, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

18. The method of claim 10, wherein the second aryl amine is o-anisidine.

19. The method of claim 10, wherein the temperature and time are sufficient to decrease the concentration of the N-arylacetoacetamide by at least about 80% on a mass basis relative to the N-arylacetoacetarylide pigment composition in the pigment dispersion.

20. A pigment dispersion comprising:
an N-arylacetoacetarylide pigment composition dispersed in an aqueous phase in the presence of a polymeric dispersant and/or at least one surfactant, the N-arylacetoacetarylide pigment composition comprising a diazonium coupling product of a first aryl amine and an N-arylacetoacetamide formed from a second aryl amine;
wherein a concentration of residual N-arylacetoacetamide in the pigment dispersion is about 4000 μg/g pigment or below.
